(19) United States
(12) Patent Application Publication
(10) Pub. No.: US 2004/0043501 A1
(43) Pub. Date: Mar. 4, 2004

(54) Monitoring of downhole parameters and chemical injection utilizing fiber optics

(75) Inventors: C. Mitch Means, Needville, TX (US); Alan Clemmit, Kingwood, TX (US); Benn Voll, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated, Houston, TX

(21) Appl. No.: 10/456,645

(22) Filed: Jun. 6, 2003

Related U.S. Application Data
(63) Continuation-in-part of application No. 09/872,591, filed on Jun. 1, 2001, now Pat. No. 6,588,266.
Application No. 09/872,591 is a division of application No. 09/070,953, filed on May 1, 1998, now Pat. No. 6,268,911.
(60) Provisional application No. 60/045,354, filed on May 2, 1997.
(60) Provisional application No. 60/048,989, filed on Jun. 9, 1997.
(60) Provisional application No. 60/052,042, filed on Jul. 9, 1997.
(60) Provisional application No. 60/062,953, filed on Oct. 10, 1997.
(60) Provisional application No. 60/073,425, filed on Feb. 2, 1998.
(60) Provisional application No. 60/079,446, filed on Mar. 26, 1998.

(51) Int. Cl. G01N 21/00

(52) U.S. Cl. 436/164

(57) ABSTRACT

The present invention provides systems utilizing fiber optics for monitoring downhole parameters and the operation of systems for injection of treatment chemicals. In one system, fiber optics sensors are placed in the wellbore to make distributed measurements for determining the fluid parameters including temperature, pressure, fluid flow, fluid constituents and chemical properties. Optical spectrophotometric sensors are employed for monitoring chemical properties in the wellbore and, optionally, at the surface for chemical injection systems

### CROSS REFERENCE TO RELATED APPLICATIONS

This application is a continuation in part of U.S. patent application Ser. No. 09/872,591 filed on Jun. 1, 2001, now U.S. Pat. No. ______ , which is a divisional application Ser. No, 09/070,953, now U.S. Pat. No. 6,268,911 B1, which claims priority from Provisional U.S. Patent Applications Ser. Nos. 60/045,354 filed on May 2, 1997; 60/048,989 filed on Jun. 9, 1997; 60/052,042 filed on Jul. 9, 1997; 60/062,953 filed on Oct. 10, 1997; 67/073,425 filed on Feb. 2, 1998; and 60/079,446 filed on Mar. 26, 1998. Additionally, this application also claims priority from U.S. Pat. application Ser. No. 09/210,496 filed Dec. 11,1998, which is a continuation in part of U.S. application Ser. No. 09/082,246 filed May 20,1998, which claims the benefit of U.S. Provisional Patent Application having Serial No. 60/062,953 filed Oct. 10, 1997 and Serial No. 60/048,989 filed Jun. 9, 1997.

### BACKGROUND OF THE INVENTION

1. Field of the Invention

This invention relates generally to oilfield operations and more particularly to systems and methods utilizing fiber optics for monitoring wellbore parameters and production fluid parameters.

2. Background of the Art

A variety of techniques have been utilized for monitoring reservoir conditions, estimation and quantities of hydrocarbons (oil and gas) in earth formations, for determination formation and wellbore parameters and for determining the operating or physical condition of downhole tools.

Reservoir monitoring typically involves determining certain downhole parameters in producing wellbores, such as temperature and pressure placed at various locations in the producing wellbore, frequently over extended time periods. Wireline tools are most commonly utilized to obtain such measurements, which involves shutting down the production for extended time periods to determine pressure and temperature gradients over time.

Seismic methods wherein a plurality of sensors are placed on the earth's surface and a source placed at the surface or downhole are utilized to obtain seismic data which is then used to update prior three dimensional (3-D″) seismic maps. Three-dimensional maps updated over time are sometimes referred to as “4-D” seismic maps. The 4-D maps provide useful information about reservoirs and subsurface structure. These seismic methods are very expensive. The wireline methods are utilized at great time intervals, thereby not providing continuous information about the wellbore conditions or that of the surrounding formations.

Permanent sensors, such as temperature sensors, pressure sensors, accelerometers or hydrophones have been placed in the wellbores to obtain continuous information for monitoring wellbores and the reservoir. Typically, a separate sensor is utilized for each type of parameter to be determined. To obtain such measurements from useful segments of each wellbore, which may contain multilateral wellbores, requires using a large number of sensors, which require a large amount of power, data acquisition equipment and relatively large amount of space, which in many cases is impractical or cost prohibitive.

In production wells, chemicals are often injected downhole to treat the fluids being produced. However, it can be difficult to monitor and control such chemical injection in real time. Similarly, chemicals are typically used at the surface to treat the produced hydrocarbons, for example to break down emulsions and to inhibit corrosion. However, it can be difficult to monitor and control such treatments in real time.

Formation parameters are most commonly measured by measurement-while-drilling tools during the drilling of the wellbores and by wireline methods after the wellbores have been drilled. The conventional formation evaluation sensors are complex and large in size and thus require large tools. Additionally such sensors are very expensive.

The present invention addresses some of the above-described prior deficiencies and provides systems and methods that utilize a variety of fiber optic sensors for monitoring wellbore parameters and production fluid parameters. In some applications, the same sensor is configured to provide more than one measurement. In many instances these sensors can operate at higher temperatures than the conventional sensors.

### SUMMARY OF THE INVENTION

The present invention provides fiber optics based systems and methods for monitoring downhole parameters and production fluid parameters. The sensors may be permanently disposed downhole. The light source for the fiber optic sensors may be disposed in the wellbore or at the surface. The measurements from such sensors may be processed downhole and/or at the surface. Data may also be stored for use for processing. Certain sensors may be configured to provide multiple measurements. The measurements made by the fiber optic chemical sensors in the present invention can include qualitative and quantitative detection of (i) organic precipitates, (ii) hydrogen sulfide, (iii) scale, (iv) asphaltenes, (v) paraffins, (vi) methane hydrates, (vii) foam, and (viii) corrosion.

In one system of the present invention, a plurality of spaced apart fiber optic sensors is disposed in the wellbore to take the desired measurements. The light source and the processor may be disposed in the wellbore or at the surface. Two-way communication between the sensors and the processor is provided via fiber optic links or by conventional methods. A single light source may be utilized in the multilateral wellbore configurations. The sensors may be permanently installed in the wellbores during the completion or production phases. The sensors preferably provide measurements of temperature pressure and flow for monitoring the wellbore production and for performing reservoir analysis.

In another system of the present invention, a single chemical sensor or a combination of single and distributed sensors is disposed in the wellbore to take the desired measurements. These single sensors can be selected from the group consisting of a fiber optic attenuated total reflectance probe, transmission probe, and a reflectance probe.

The single or distributed sensors of this invention find particular utility in the monitoring and control of various chemicals that are injected into the well. Such chemicals are injected downhole to address a large number of known problems such as (i) organic precipitates, (ii) hydrogen sulfide, (iii) scale, (iv) asphaltenes, (v) paraffins, (vi) methane hydrates, (vii) foam, and (viii) corrosion. In accordance with the present invention, a chemical injection monitoring and control system includes the placement of one or more sensors downhole in the producing zone for measuring the chemical properties of the produced fluid as well as for measuring other downhole parameters of interest. These sensors are fiber optic based and are selected from the group consisting of a fiber optic attenuated total reflectance probe, a transmission probe, and a reflectance probe. The downhole chemical sensors may be associated with a network of distributed fiber optic sensors positioned along the wellbore for measuring pressure, temperature and/or flow. Surface and/or downhole controllers receive input from the several downhole sensors, and in response thereto, control the injection of chemicals into the borehole or into production fluid at the surface.

The chemical parameters are preferably measured in real time and on-line and then used to control the amount and timing of the injection of the chemicals into the wellbore or for controlling a surface chemical treatment system.

An optical spectrophotometer may be used downhole to determine the properties of downhole fluid, especially production fluid. The spectrophotometer includes a quartz probe in contact with the fluid. Optical energy provided to the probe, preferably from a downhole source. The fluid properties such as the density, amount of oil, water, gas and solid contents affect the refraction of the light. The refracted light is analyzed to determine the fluid properties. The spectrophotometer may be permanently installed downhole. Of course, the spectrophotometer can also be located at the surface.

Examples of the more important features of the invention have been summarized rather broadly in order that the detailed description thereof that follows may be better understood, and in order that the contributions to the art maybe appreciated. There are, of course, additional features of the invention that will be described hereinafter and which will form the subject of the claims appended hereto.

### BRIEF DESCRIPTION OF THE DRAWINGS

For a detailed understanding of the present invention, reference should be made to the following detailed description of the preferred embodiments, taken in conjunction with the accompanying drawings, in which like elements have been given like numerals, wherein:

FIG. 1 shows a schematic illustration of a multilateral wellbore system and placement of fiber optic sensors according to one embodiment of the present invention.

FIG. 2 is a schematic illustration of a chemical injection monitoring and control system utilizing a distributed sensor arrangement and downhole chemical monitoring sensor system in accordance with one embodiment of the present invention;

FIG. 3 is a schematic illustration of an interface between fiber optic chemical sensor probe and a spectrophotometer;

FIG. 4 is a schematic illustration of a surface treatment system and chemical injection control system in accordance with the present invention; and

### DETAILED DESCRIPTION OF PREFERRED EMBODIMENTS

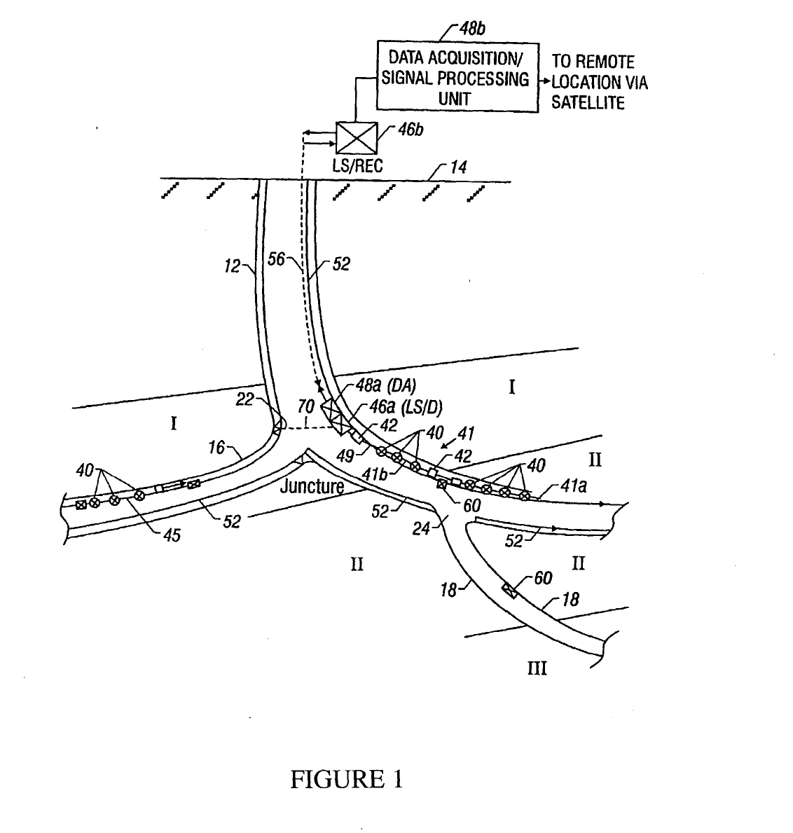

FIG. 1 shows an exemplary main or primary wellbore 12 formed from the surface 14 and lateral wellbores 16 and 18 formed from the main wellbore 18. For the purpose of explanation, and not as any limitation, the main wellbore 12 is partly formed in a producing formation or pay zone I and partly in a non-producing formation or dry formation II. The lateral wellbore 16 extends from the main wellbore 12 at a juncture 24 into a second producing formation III. For the purposes of illustration, the wellbores herein are shown drilled from land, however, this invention is equally applicable to offshore wellbores. It should be noted that all wellbore configurations shown and described herein are to illustrate the concepts of present invention and shall not be construed to limit the inventions claimed herein.

In one application, a number of fiber optic sensors 40 are place in the wellbore 12. A single or a plurality of fiber optic sensors 40 may be used so as to install the desired number of fiber optic sensors 40 in the wellbore 12. As an example, FIG. 1 shows two serially coupled fiber optic segments 41a and 41b, each containing a plurality of spaced apart fiber optic sensors 40. A light source and detector (LS) 46a coupled to an end 49 of the segment 41a is disposed in the wellbore 12 to transmit light energy to the sensors 40 and to receive the reflected light energy from the sensors 40. A data acquisition and processing unit (TDA) 48a (also referred to herein as a “processor” or “controller”) may be disposed downhole to control the operation of the sensors 40, to process downhole sensor signals and data, and to communicate with other equipment and devices, including devices in the wellbores or at the surface (not shown).

Alternatively, a light source 46b and/or the data acquisition and processing unit 48b may be place at the surface 14. Similarly, fiber optic sensor strings 45 may be disposed in other wellbores in the system, such as wellbores 16 and wellbore 18. A single light source, such as the light source 46a or 46b may be utilized for all fiber optic sensors in the various wellbores, such as shown by dotted line 70. Alternatively, multiple light sources and data acquisition units may be used downhole, at the surface or in combination. Since the same sensor may make different types of measurements, the data acquisition unit 48a or 48b is programmed to multiplex the measurement. Also different types of sensors may be multiplexed as required. Multiplexing techniques are know in the art and are thus not described in detail herein. The data acquisition unit 46a may be programmed to control the downhole sensors 40 autonomously or upon receiving command signals from the surface or a combination of these methods.

The sensors 40 may be installed in the wellbores 12, 16, and 18 before or after installing casings in wellbores, such as casing 52 shown installed in the wellbore 12. This may be accomplished by connecting the strings 41a and 41b along the inside of the casing 52. In one method, the strings 41a and 41b may be deployed or installed by robotics devices (not shown). The robotics device would move the sensor strings 41a and 41b within the wellbore 12 to the desired location and install them according to programmed instructions provided to the robotics device. The robotics device may also be utilized to replace a sensor, conduct repairs retrieve the sensors or strings to the surface and monitor the operation of downhole sensors or devices and gather data. Alternatively, the fiber optic sensors 40 maybe placed in the casing 52 (inside, wrapped around, or in the casing wall) at the surface while individual casing sections (which are typically about forty-foot long) are joined prior to conveying the casing sections into the borehole. Stabbing techniques for joining casing or tubing sections are known in the art and are preferred over rotational joints because stabbing generally provides better alignment of the end couplings 42 and also because it allows operators to test and inspect optical connections between segments for proper two-way transmission of light energy through the entire string 41. For coiled tubing applications, the sensors may be wrapped on the outside or placed in conduit inside the tubing. Light sources and data acquisition unit may also be placed in the coiled tubing prior to or after deployment.

Thus, in the system described in FIG. 1, a plurality of fiber optic sensors 40 are installed spaced apart in one or more wellbores, such as wellbores 12, 16 and 18. If desired, each fiber optic sensor 40 can be configured to operate in more than one mode to provide a number of different measurements. The light source 46a, and data detection and acquisition system 48a may be placed downhole or at the surface. Although each fiber optic sensor 40 may provide measurements for multiple parameters, such sensors are still relatively small compared to individual commonly used single measurement sensors, such as pressure sensors, strain gauges, temperature sensors, flow measurement devices and acoustic. sensors.

This enables making a large number of different types of measurements utilizing relatively small downhole space. Installing data acquisition and processing devices or units 48a downhole allows making a large number of data computations and processing downhole, avoiding the need of transmitting large amounts of data to the surface. Installing the light source 46a downhole allows locating the source 46a close to the sensors 40, which avoids transmitting light to great distances from the surface thus avoiding loss of light energy. The data from the downhole acquisition system 48a may be transmitted to the surface by any suitable communication links or method including optical fibers, wire connections, electromagnetic telemetry and acoustic methods. Data and signals may be transmitted downhole using the same communication links. Still in some applications, it may be desirable to locate the light source 46b and/or the data acquisition and processing system 48b at the surface. Also, in some cases, it may be more advantageous to partially process data downhole and partially at the surface.

In the present invention, the fiber optic sensors 40 may be configured to provide measurements for temperature, pressure, flow, liquid level displacement, vibration, rotation, acceleration, velocity, chemical species and concentration, radiation, pH, humidity, electric fields, acoustic fields and magnetic fields.

Still referring to FIG. 1, any number of conventional sensors, generally denoted herein by numeral 60, may be disposed in any of the wellbores 12, 16 and 18. The measurements from the fiber optic sensors 40 and conventional sensors 60 may be combined to determine the various conditions downhole or used as input for controlling the injection of chemicals into the surface treatment system. In one mode, the fiber optic sensors are permanently installed in the wellbores at selected locations. In a producing wellbore, the sensors continuously or periodically (as programmed) provide the pressure and/or temperature and/or fluid flow measurements. Such measurements are preferably made for each producing zone in each of the wellbores. These measurements are then utilized to determine the presence of an undesirable condition, such as high levels of asphaltenes, and then be used to calculate the optimum amount of chemicals to be injected to suppress the precipitation of the asphaltenes.

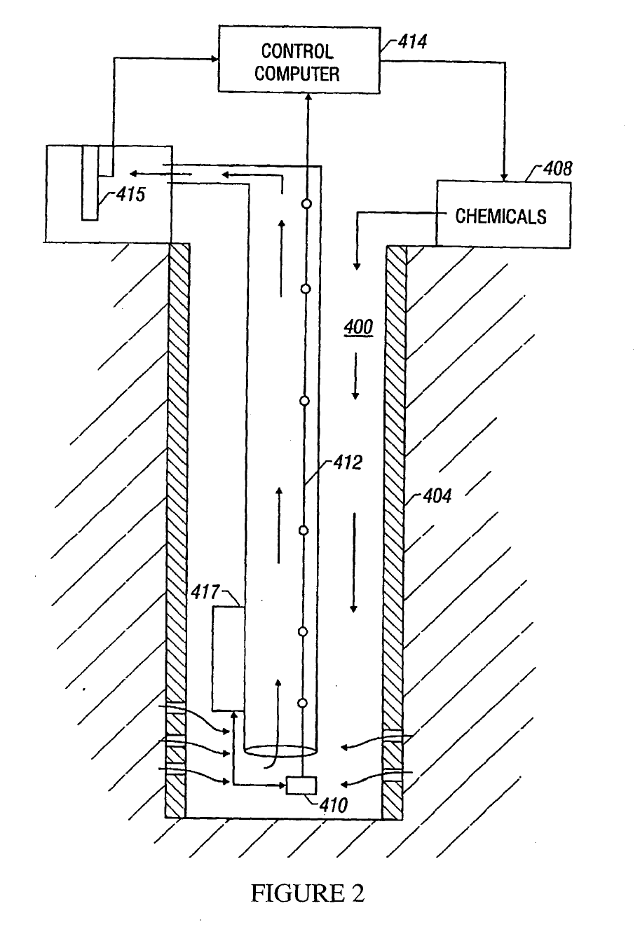

Referring now to FIG. 2, the distributed fiber optic sensors of the type described above are well suited for use in a production well where chemicals are being injected therein and there is a resultant need for the monitoring of such a chemical injection process so as to optimize the use and effect of the injected chemicals. Chemicals often need to be pumped down a production well for inhibiting scale, paraffins and the like as well as for other known processing applications and pretreatment of the fluids being produced. Often, as shown in FIG. 2, chemicals are introduced in an annulus 400 between the production tubing 402 and the casing 404 of a well 406, however, for the purposes of the present invention, the chemicals can also be introduced into the production tubing downhole, into the producing area of a well, into the producing area of a well using a capillary tubing, or even into the production fluid after it reaches the surface. One preferred method of getting the chemicals into the production tubing downhole is known as “squeezing.” This technique involves flushing the chemical downhole through the production tubing, normally diluted in water or oil. The chemical is then over flushed with water, oil or diesel such that it is squeezed into the reservoir up to a distance of several feet. The chemical then adsorbs onto the reservoir rock and when the well is brought back onto production the chemical slowly feeds back and protects the reservoir, tubing and topside facilities.

The chemical injection (shown schematically at 408) can be accomplished in a variety of known methods such as in connection with a submersible pump (as shown for example in U.S. Pat. No. 4,582,131, assigned to the assignee hereof and incorporated herein by reference) or through an auxiliary line associated with a cable used with an electrical submersible pump (such as shown for example in U.S. Pat. No. 5,528,824, assigned to the assignee hereof and incorporated herein by reference). The chemical injection can be accomplished using any method known to those of ordinary skill in the art of treating production fluid to be useful.

In accordance with an embodiment of the present invention, one or more bottomhole sensors 410 are located in the producing zone 405 for sensing a variety of parameters associated with the producing fluid and/or interaction of the injected chemical and the producing fluid 407. Thus, the bottomhole sensors 410 will sense parameters relative to the chemical properties of the produced fluid such as the potential ionic content, the covalent content, pH level, oxygen levels, organic precipitates, and like measurements. Sensors 410 can also measure physical properties associated with the producing fluid and/or the interaction of the injected chemicals and producing fluid such as the oil/water cut, viscosity and percent solids. Sensors 410 can also provide information related to paraffin and scale build-up, H₂S content and the like.

Bottomhole sensors 410 preferably communicate with and/or are associated with a plurality of distributed sensors 412 which are positioned along at least a portion of the wellbore (e.g., preferably the interior of the production tubing) for measuring pressure, temperature and/or flow rate as discussed above in connection with FIG. 1. The present invention is also preferably associated with a surface control and monitoring system 414 and one or more known surface sensors 415 for sensing parameters related to the produced fluid; and more particularly for sensing and monitoring the effectiveness of treatment rendered by the injected chemicals. The sensors 415 associated with surface system 414 can sense parameters related to the content and amount of, for example, hydrogen sulfide, hydrates, paraffins, water, solids and gas.

The production well disclosed in FIG. 2 can have associated therewith a so-called “intelligent” downhole control and monitoring system. This control and monitoring system can be of the type disclosed in U.S. Pat. No. 5,597,042, which is assigned to the assignee hereof and fully incorporated herein by reference. As disclosed in U.S. Pat. No. 5,597,042, the sensors in the “intelligent” production wells of this type are associated with downhole computer and/or surface controllers which receive information from the sensors and based on this information, initiate some type of control for enhancing or optimizing the efficiency of production of the well or in some other way effecting the production of fluids from the formation. In the present invention, the surface and/or downhole computers 414, 418 will monitor the effectiveness of the treatment of the injected chemicals and based on the sensed information, the control computer will initiate some change in the manner, amount or type of chemical being injected. In the system of the present invention, the sensors 410 and 412 may be connected remotely or in-situ.

In a preferred embodiment, the control system is a SENTRYNET™ available from Baker Petrolite, a division of Baker-Hughes Incorporated, of Houston, Tex. The system consists of an electronic or electro-pneumatic pump control module, which provides control of the injection pump. Integral to the control module is a high-precision flow meter. The flow meter reads the actual pumped flow rate and is extremely accurate at injection rates as low as one quart per day. Such systems can be controlled remotely using a second controller connected using wired or wireless technology. The SentryNet system provides an electronic communication and control interface for the chemical pump. In one preferred embodiment, several control systems are connected to a single remote controller using a local area network.

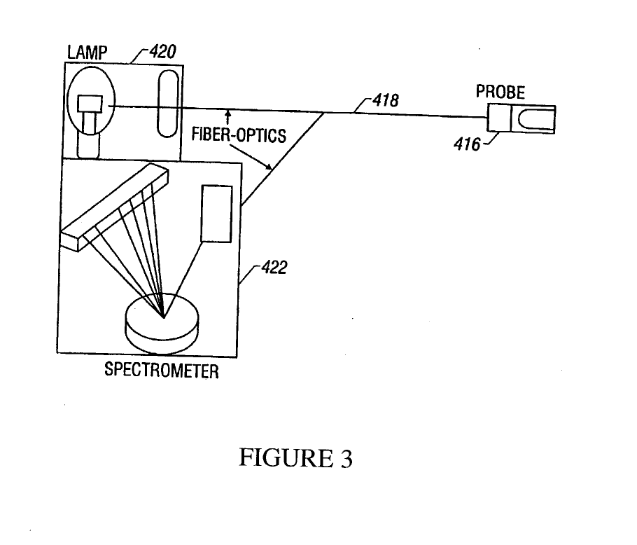

In a preferred embodiment of the present invention, the downhole sensors comprise fiber optic chemical sensors. Such fiber optic chemical sensors preferably utilize fiber optic probes that are used as a sample interface to allow light from the fiber optic to interact with the liquid or gas stream and return to a spectrophotometer for measurement. The fiber optic chemical sensors are selected from the group consisting of fiber optic attenuated total reflectance probes, transmission probe, and reflectance probes. Referring to FIG. 3, a probe is shown at 416 connected to a fiber optic cable 418 that is in turn connected both to a light source 420 and a spectrophotometer 422.

The fiber optic chemical sensors useful with the present invention include fiber optic attenuated total reflectance probes such as disclosed in U.S. Patent Application Publication 2003/0071988 A1 and U.S. Pat. No. 6,467,340 B1, both of which are assigned to the assignee hereof and incorporated herein by reference. Another type of fiber optic chemical sensor useful with the present invention is the fiber optic transmission probe such as is disclosed in U.S. Pat. No. 6,461,414. This patent is also assigned to the assignee hereof and incorporated herein by reference.

Still another type of fiber optic probe useful with the present invention is a reflectance probe. One such probe is the Model P-RR from Control Development, Inc. Any such probe that is prepared such that it can tolerate the temperatures and pressures of downhole operations can be used with the method of the present invention.

In one embodiment of the present invention, light from the light source 420 is sent to the chemical sensor probe by means of the fiber optic cable 418. That light interacts with the production fluid in contact with the probe and returned to the fiber optical cable. Light transmitted by the fiber optic cable to the spectrophotometer is measured by the spectrophotometer 422. The spectrophotometer 422 (as well as light source 420) may be located either at the surface or at some location downhole.

Based on the spectrophotometer measurements, a control computer 414 will analyze the measurement and based on this analysis, the chemical injection apparatus 408 will change the amount, concentration, rate and/or type of chemical being injected downhole into the well. Information from the chemical injection apparatus relating to amount of chemical left in storage, chemical quality level and the like can also be sent to the control computers. The control computer may also base its control decision on input received from surface sensor 415 relating to the effectiveness of the chemical treatment on the produced fluid, the presence and concentration of any impurities or undesired by-products and the like.

In addition to the bottomhole sensors 410 being comprised of the fiber optic chemical sensors; distributed sensors 412 along production tubing 402 may also include the fiber optic chemical sensors of the type discussed above. In this way, the chemical content of the production fluid may be monitored as it travels up the production tubing if that is desirable. Also, single sensors similar to the bottom hole sensors can be placed at selected points in the wellbore both above and below the production zones. For example, bottom hole sensors could be placed in both Zone I and II in one alternative embodiment of the present invention.

The permanent placement of the sensors 410, 412 and control system 417 downhole in the well leads to a significant advance in the field and allows for real time, remote control of chemical injections into a well without the need for wireline device or other well interventions.

In accordance with the present invention, a novel control and monitoring system is provided for use in connection with a treating system for handling produced hydrocarbons in an oilfield. In a typical surface treatment system used for treating produced fluid in oil fields, the fluid produced from the well includes a combination of emulsion, oil, gas and water. After these well fluids are produced to the surface, they are contained in a pipeline known as a “flow line.” The flow line can range in length from a few feet to several thousand feet. Typically, the flow line is connected directly into a series of tanks and treatment devices that are intended to provide separation of the water in emulsion from the oil and gas. In addition, it is intended that the oil and gas be separated for transport to the refinery.

In accordance with an important feature of the present invention, sensors are used in chemical treatment systems that monitor the chemicals themselves as opposed to the effects of the chemicals (for example, the rate of corrosion). Such sensors provide the operator of the treatment system with a real time understanding of the amount of chemical being introduced, the transport of that chemical throughout the system, the concentration of the chemical in the system and like parameters.

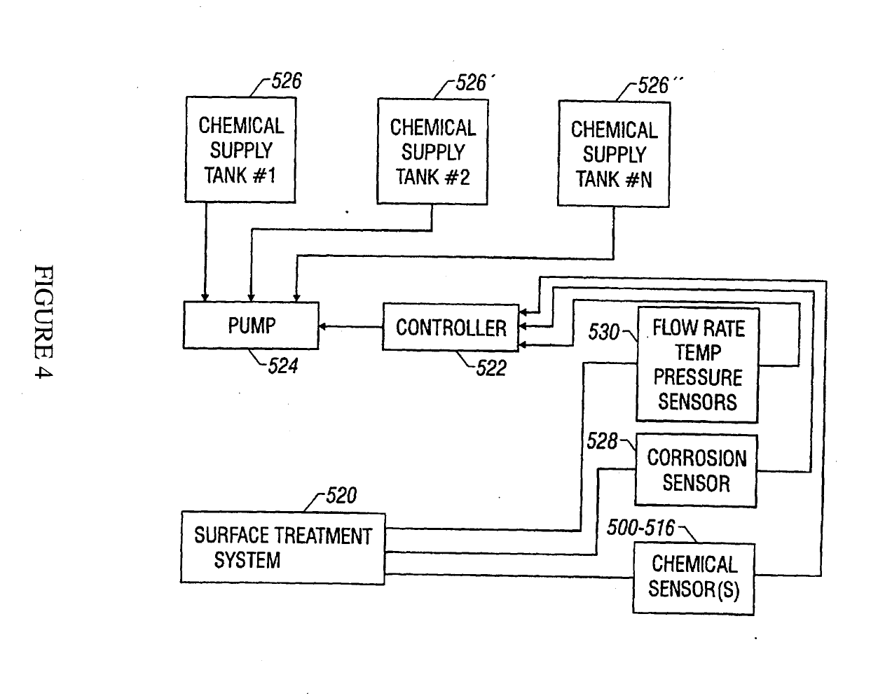

Referring now to FIG. 4, the surface treatment system is shown generally at 520. In accordance with the present invention, the chemical sensors 500-516 will sense, in real time, parameters related to the introduced chemicals and properties of the produced fluids and supply that sensed information to a controller 522, which is preferably a computer or microprocessor based controller. Based on that sensed information monitored by controller 522, the controller will instruct a pump or other metering device 524 to maintain, vary or otherwise alter the amount of chemical and/or type of chemical being added to the surface treatment system 520. The supplied chemical from tanks 526 can, of course, comprise any suitable treatment chemical, often referred to as additives, such as those chemicals used to treat corrosion, break down emulsions, and the like. Suitable commercially available chemicals include CRONOX FILM-PLUS® corrosion inhibitor, EnviroSweet® Sulfide Inhibitor, and other products from Baker Petrolite, a division of Baker-Hughes Incorporated, of Houston, Texas. Preferably, the additives are selected from the group consisting of i) corrosion inhibitors, (ii) de-emulsifiers, (iii) dewaxers, (iv) scale inhibitors, (v) hydrogen sulfide scavengers, (vi) hydrate inhibitors, (vii) biocides, (viii) foamers, (ix) defoamers, (x) asphaltene inhibitors, (xi) scale inhibitors, (xii) water clarifiers, (xiii) drag reducers, and (xiv) mixtures thereof. Any additive known to those of ordinary skill in the art of producing oil and gas to be useful can be used with the method of the present invention.

Thus, in accordance with the control and monitoring system of FIG. 4, based on information provided by the chemical sensors 500-516, corrective measures can be taken for varying the injection of the additives into the system.

The injection point of these chemicals could be anywhere upstream of the location being sensed such as the location where the corrosion is being sensed. Of course, this injection point could include injections downhole. In the context of a corrosion inhibitor, the inhibitors work by forming a protective film on the metal and thereby prevent water and corrosive gases from corroding the metal surface. Other surface treatment chemicals include emulsion breakers that break the emulsion and facilitate water removal. Each type of chemical is preferably added in an amount and at a rate relative to production to achieve an improvement is some parameter of the production fluid.

In addition to the parameters relating to the chemical introduction being sensed by chemical sensors 500-516, the monitoring and control system of the present invention can also utilize known conventional sensors such as corrosion sensors and flow rate, temperature and pressure sensors. These other sensors are schematically shown in FIG. 4 at 528 and 530. The present invention thus provides a means for measuring parameters related to the introduction of chemicals into the system in real time and on line. As mentioned, these parameters include chemical concentrations and may also include such chemical properties as potential ionic content, the covalent content, pH level, oxygen levels, organic precipitates, and like measurements. Similarly, oil/water cut viscosity and percent solids can be measured as well as paraffin and scale build-up, H₂S content and the like. The fiber optic sensors described above may be used to determine the. above mentioned parameters downhole.

While foregoing disclosure is directed to the preferred embodiments of the invention, various modifications will be apparent to those skilled in the art. It is intended that all variations within the scope and spirit of the appended claims be embraced by the foregoing disclosure.

What is claimed is:

1. A method of monitoring chemical injection into a treatment system of an oilfield well, comprising:
(a) injecting one or more chemicals into the treatment system for treatment of a fluid produced in the oilfield well; and
(b) sensing at least one chemical property of the fluid in the treatment system using at least one fiber optic chemical sensor associated with the treatment system,
wherein at least one fiber optic chemical sensor is a fiber optic attenuated total reflectance probe, transmission probe, or a reflectance probe.

2. The method of claim 1 wherein the at least one fiber optic chemical sensor additionally comprises an optical spectrophotometer.

3. The method of claim 1 wherein the one or more chemicals are injected into an annulus between the production tubing and the casing of the well, into a production tubing, into the producing area of a well, into the producing area of a well using a capillary tubing, or into a surface treatment system.

4. The method of claim 1 wherein at least one chemical property is selected from the group consisting of (i) organic precipitate level, (ii) hydrogen sulfide, (iii) scale, (iv) asphaltenes, (v) paraffins, (vi) methane hydrates, (vii) foam, and (viii) corrosion.

5. The method of claim 1 further comprising monitoring the produced fluid for parameters related to the content and amount of at least one of (i) organic precipitate level, (ii) hydrogen sulfide, (iii) scale, (iv) asphaltenes, (v) paraffins, (vi) methane hydrates, (vii) foam, and (viii) corrosion..

6. The method of claim 3 further comprising using distributed sensors along the production tubing for monitoring chemical content of the fluid as it travels up the production tubing.

7. The method of claim 1 further comprising using a determined value of the at least one chemical property for controlling the injection of the at least one or more chemicals.

8. The method of claim 1 wherein the at least one or more chemicals are selected from the group consisting of: (i) corrosion inhibitors, (ii) de-emulsifiers, (iii) dewaxers, (iv) scale inhibitors, (v) hydrogen sulfide scavengers, (vi) hydrate inhibitors, (vii) biocides, (viii) foamers, (ix) defoamers, (x) asphaltene inhibitors, (xi) scale inhibitors, (xii) water clarifiers, (xiii) drag reducers, and (xiv) mixtures thereof.

9. The method of claim 1 wherein an injection location for the one or more chemicals is upstream of a location of the at least one fiber optic sensor.

10. The method of claim 1 further comprising using at least one additional sensor selected from the group consisting of (i) flow rate sensors, (ii) temperature sensors, and, (iii) pressure sensors for monitoring fluid in the well.

11. The method of claim 10 further comprising using data from the at least one additional sensor as an input into an algorithm to determine the rate of injection of the one or more chemicals.

12. The method of claim 10 further comprising using data from the at least one additional sensor as an input into an algorithm to select which one of the one or more chemicals to be injected.

13. A method of monitoring chemical injection into a treatment system of an oilfield well, comprising:
(a) injecting one or more chemicals into the treatment system for the treatment of a fluid produced from the oilfield well; and
(b) sensing at least one chemical property of the fluid using at least one fiber optic chemical sensor permanently installed in the well,
wherein the at least one fiber optic chemical sensor is a fiber optic attenuated total reflectance probe, transmission probe, or a reflectance probe.

14. The method of claim 13 wherein the one or more chemicals are injected into an annulus between the production tubing and the casing of the well, into a production tubing, into the producing area of a well, into the producing area of a well using a capillary tubing or into a surface treatment system.

15. The method of claim 14 further comprising using a determined value of the at least one chemical property for controlling the injection of the at least one or more chemicals.

16. The method of claim 15 further comprising using at least one additional sensor selected from the group consisting of (i) flow rate sensors, (ii) temperature sensors, and, (iii) pressure sensors for monitoring fluid in the well.

17. The method of claim 13 wherein the at least one fiber optic chemical sensor permanently installed in the well is located near the producing level of the well.

18. The method of claim 13 wherein the at least one fiber optic chemical sensor permanently installed in the well is located near the top level of the well.

19. The method of claim 13 wherein the at least one fiber optic chemical sensor permanently installed in the well is located in a well having more than one producing level and the at least one fiber optic chemical sensor permanently installed in the well is located at or near the lowest producing level.

20. The method of claim 13 wherein the at least one fiber optic chemical sensor permanently installed in the well is located in a well having more than one producing level and the at least one fiber optic chemical sensor permanently installed in the well is located at or near the highest producing level.

21 A microprocessor controlled method of monitoring chemical injection into a treatment system of an oilfield well, comprising:
(a) injecting one or more chemicals into the treatment system for treatment of a fluid produced in the oilfield well; and
(b) sensing at least one chemical property of the fluid in the treatment system using at least one fiber optic chemical sensor associated with the treatment system,
wherein the at least one fiber optic chemical sensor is a fiber optic attenuated total reflectance probe, transmission probe, or a reflectance probe and the injection of one or more chemicals and the sensing at least one chemical property is done using a first microprocessor.

22. The method of claim 21 further comprising using the data from the sensors to inject the one or more chemicals in an amount sufficient to eliminate or reduce an undesirable property of the production fluid.

23. The method of claim 22 further comprising using a second microprocessor to program and communicate with the first microprocessor.

24. The method of claim 23 wherein the first microprocessor is located at or near the well site and the second microprocessor is in a location remote from the first microprocessor.
